(19) United States
(12) Patent Application Publication
(10) Pub. No.: US 2025/0139898 A1
(43) Pub. Date: May 1, 2025

(54) OBJECT RENDERING METHOD AND APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventors: Guohua CONG, Beijing (CN); Yansheng FU, Beijing (CN)

(21) Appl. No.: 18/837,715

(22) PCT Filed: Mar. 15, 2023
(86) PCT No.: PCT/CN2023/081615

§ 371 Date: Aug. 12, 2024

(30) Foreign Application Priority Data
Mar. 29, 2022 (CN) 202210323943.2
Mar. 29, 2022 (CN) 202210323944.7

(51) Int. Cl. G06T 17/20; G06F 3/01; G06T 7/50; G06T 7/70; G06T 15/04

(52) U.S. Cl. CPC G06T 17/20; G06F 3/013; G06T 7/50; G06T 7/70; G06T 15/04; G06T 2210/21; G06T 2210/36

(57) ABSTRACT

The present disclosure relates to an object rendering method and apparatus, an electronic device, a storage medium, and a program product, which can avoid tearing a rendered target object due to the fact that optimized rendering is performed on a scene to be rendered to improve the rendering efficiency and improving the user experience. The method comprises: acquiring first position information of a target object in a scene to be rendered in a screen; and rendering, in a case that the first position information indicates that an intersection of the target object and a user gaze area satisfies a preset condition, the target object based on a first rendering strategy, wherein the first rendering strategy is a strategy of rendering P×Q pixel points at a time, and P and Q are positive integers.

### PRIORITIES

This application claims priorities to Chinese Patent Application No. “202210323943.2,” entitled “Object Rendering Method, Apparatus, Electronic Device, Storage Medium, and Program Product,” filed on Mar. 29, 2022, and Chinese Patent Application No. “202210323944.7,” entitled “Rendering Strategy Determination Method, Apparatus, Electronic Device, Medium, and Program Product,” filed on Mar. 29, 2022. The contents of both applications are incorporated herein by reference.

### FIELD

The present disclosure relates to a field of scene rendering technology, and in particular, to an object rendering method and apparatus, an electronic device, a storage medium, and a program product.

### BACKGROUND

Due to the structure of the human eye, the clarity of the human eye gaze area is the highest, while the clarity of the periphery of the gaze area decreases. Foveated Rendering (FR) takes advantage of this characteristic of the human eye by rendering the human eye gaze area at high resolution and rendering the area outside the gaze area at low resolution, in order to improve rendering speed and save the computational power of the graphics processing unit (GPU).

However, an advantage of FR is its relative simplicity, but simplicity implies roughness. Typically, after FR processing, different parts of the same object in the image will have different resolutions. For example, as to a wall, its part near the display boundary may appear blurry, while the central part is very clear. Consequently, after FR processing, users may experience a sense of object tearing, leading to a poor user experience.

### SUMMARY

To solve the above technical problems, or at least partially solve them, the present disclosure provides an object rendering method and apparatus, an electronic device, a storage medium, and a program product.

In a first aspect of the embodiments of the present disclosure, there is provided an object rendering method. The method comprises: acquiring first position information of a target object in a scene to be rendered in a screen; and in a case that the first position information indicates that an intersection of the target object and a user gaze area satisfies a preset condition, rendering the target object based on a first rendering strategy. Wherein the first rendering strategy is a strategy of rendering P×Q pixel points at a time, and P and Q are positive integers.

Optionally, in a case that the first position information indicates that the intersection of the target object and the user gaze area satisfies the preset condition, rendering the target object based on the first rendering strategy comprises: in a case that the first position information indicates that the intersection of the target object and the user gaze area satisfies the preset condition, acquiring first information of the target object; and in a case that the first information satisfies a target condition, rendering the target object based on the first rendering strategy.

Optionally, in a case that the first information comprises a first depth value of the target object after rendering, the target condition comprises that the first depth value is less than or equal to a preset depth threshold; in a case that the first information comprises a first size value of the target object, the target condition comprises that the first size value is greater than or equal to a preset size threshold; in a case that the first information comprises gradient information of a mapping region, the target condition comprises that the gradient information of the mapping region is greater than or equal to a preset gradient threshold, the mapping region is a region of the target object in a mapping corresponding to the scene to be rendered; in a case that the first information comprises a type of the target object, the target condition comprises that the type of the target object is a preset type; and in a case that the first information comprises a number of triangular faces of the target object, the target condition comprises that the number of the triangular faces of the target object is greater than or equal to a preset number threshold.

Optionally, the method further comprises: prior to rendering the target object based on the first rendering strategy, determining that rendering strategies set for the target object comprises a first rendering strategy and a second rendering strategy; wherein the second rendering strategy is a strategy of rendering S×T pixel points at a time, P×Q is less than S×T, and S and T are positive integers.

Optionally, the rendering the target object based on a first rendering strategy comprises: in a case that P×Q is less than or equal to N×M, modifying the rendering strategy of the target object from a third rendering strategy to the first rendering strategy, and rendering the target object based on the first rendering strategy, wherein the third rendering strategy is a strategy of rendering N×M pixel points at a time, and N and M are positive integers.

Optionally, the method further comprises prior to acquiring the first position information of the target object in the scene to be rendered in the screen; acquiring relevant information of the scene to be rendered; and based on the relevant information, determining a rendering strategy to be used when rendering the scene to be rendered. Wherein the rendering strategy comprises a strategy of rendering N×M pixel points at a time for at least one object in the scene to be rendered, and the at least one object comprises the target object.

Optionally, the relevant information comprises characteristic information of a mapping of the scene to be rendered. The characteristic information comprises at least one of the following: gradient information of the mapping, or content information of the mapping.

Optionally, the characteristic information comprises the gradient information of the mapping. Wherein based on the relevant information, determining a rendering strategy to be used when rendering the scene to be rendered comprises: in a case that the gradient information of the mapping is within a target gradient range, determining that a rendering strategy corresponding to the target gradient range is used when rendering the scene to be rendered.

Optionally, the characteristic information comprises the content information of the mapping. Wherein based on the relevant information, determining the rendering strategy to be used when rendering the scene to be rendered comprises: in a case that the content information of the mapping indicates that the mapping is a target content, determining that a rendering strategy corresponding to the target content is used when rendering the scene to be rendered; or, in a case that the content information of the mapping indicates that the mapping comprises a preset object, determining that a rendering strategy corresponding to the preset object is used for the preset object when rendering the scene to be rendered.

Optionally, the characteristic information further comprises the gradient information of the mapping. Wherein in a case that the content information of the mapping indicates that the mapping is the target content, determining that the rendering strategy corresponding to the target content is used when rendering the scene to be rendered comprises: in a case that the gradient information of the mapping is within a target preset gradient range and the mapping is the target content, determining that the rendering strategy corresponding to the target content is used when rendering the scene to be rendered; or, in a case that the content information of the mapping indicates that the mapping comprises the preset object. determining that the rendering strategy corresponding to the preset object is used for the preset object when rendering the scene to be rendered comprises: in a case that the gradient information of the mapping is within the target preset gradient range and the mapping comprises the preset object, determining that the rendering strategy corresponding to the preset object is used for the preset object when rendering the scene to be rendered.

Optionally, the relevant information comprises parameter information of each object in the scene to be rendered; wherein the parameter information comprises at least one of the following: a number of triangular faces of each object, or depth information of each object after rendering.

Optionally, the parameter information comprises the number of triangular faces of each object. Wherein based on the relevant information, determining the rendering strategy to be used when rendering the scene to be rendered comprises: based on the number of the triangular faces of each object, determining a proportion of objects in the scene to be rendered that satisfy a predetermined condition. Wherein the predetermined condition includes: the number of the triangular faces of the object is less than or equal to a number threshold of the triangular faces. Wherein in a case that the proportion is within a target ratio range, determining that a rendering strategy corresponding to the target ratio range is used when rendering the scene to be rendered. Alternatively based on the relevant information, determining the rendering strategy to be used when rendering the scene to be rendered comprises: based on the number of the triangular faces of each object, determining a target number range which comprises the number of the triangular faces of a first object; and determining that a rendering strategy corresponding to the target number range is used for the first object when rendering the scene to be rendered, the first object being any of the objects.

Optionally, the relevant information further comprises characteristic information of a mapping of the scene to be rendered. The characteristic information comprises gradient information of the mapping. Wherein based on the number of the triangular faces of each object, determining the proportion of objects in the scene to be rendered that satisfy the predetermined condition comprises: in a case that the gradient information of the mapping is within a target preset gradient range, based on the number of the triangular faces of each object. determining the proportion of objects that satisfy the predetermined condition in the scene to be rendered; or, based on the number of the triangular faces of each object. determining the target number range which comprises the number of the triangular faces of the first object comprises: in a case that the gradient information of the mapping is within the target preset gradient range, determining the target number range which comprises the number of the triangular faces of the first object, based on the number of the triangular faces of each object.

Optionally, the parameter information comprises the depth information of each object after rendering. Wherein based on the relevant information, determining the rendering strategy to be used when rendering the scene to be rendered comprises: based on the depth information of each object after rendering, determining a target depth range to which the depth information of the second object after rendering belongs; and determining that a rendering strategy corresponding to the target depth range is used for the second object when rendering the scene to be rendered; wherein the second object is any of each objects.

Optionally, the relevant information further comprises characteristic information of a mapping of the scene to be rendered. The characteristic information comprises: gradient information of the mapping. Wherein based on the depth information of each object after rendering, determining the target depth range to which the depth information of the second object after rendering belongs comprises: in a case that the gradient information of the mapping is within a target preset gradient range, determining the target depth range to which the depth information of the second object after rendering belongs, based on the depth information of each object after rendering.

In a second aspect of the embodiments of the present disclosure, there is provided an object rendering apparatus. The apparatus comprises: an acquisition module and a rendering module. Wherein the acquisition module is configured to acquire first position information of a target object in a scene to be rendered in a screen; and the rendering module is configured to, in a case that the first position information acquired by the acquisition module indicates that an intersection of the target object and a user gaze area satisfies a target condition, render the target object based on a first rendering strategy. Wherein the first rendering strategy is a strategy of rendering P×Q pixel points at a time, and P and Q are positive integers.

Optionally, the rendering module is specifically configured to, in a case that the first position information indicates that the intersection of the target object and the user gaze area satisfies the preset condition, acquire the first information of the target object; and in a case that the first information satisfies a target condition, render the target object based on the first rendering strategy.

Optionally, in a case that the first information comprises a first depth value of the target object after rendering, the target condition comprises that the first depth value is less than or equal to a preset depth threshold. In a case that the first information comprises a first size value of the target object, the target condition comprises that the first size value is greater than or equal to a preset size threshold. In a case that the first information comprises gradient information of a mapping region, the target condition comprises that the gradient information of the mapping region is greater than or equal to a preset gradient threshold, and the mapping region is a region of the target object in a mapping corresponding to the scene to be rendered. In a case that the first information comprises a type of the target object, the target condition comprises that the type of the target object is a preset type. And in a case that the first information comprises a number of triangular faces of the target object, the target condition comprises that the number of the triangular faces of the target object is greater than or equal to a preset number threshold.

Optionally, the apparatus further comprises a determination module configured to, prior to rendering the target object based on the first rendering strategy; determine that rendering strategies set for the target object comprises a first rendering strategy and a second rendering strategy. The second rendering strategy is a strategy of rendering S×T pixel points at a time, P×Q is less than S×T, and S and T are positive integers.

Optionally, the rendering module is specifically configured to, in a case that P×Q is less than or equal to N×M, modify the rendering strategy of the target object from a third rendering strategy to the first rendering strategy, and render the target object based on the first rendering strategy. The third rendering strategy is a strategy of rendering N×M pixel points at a time, and N and M are positive integers.

Optionally, the apparatus further comprises a determination module. The acquisition module is further configured to, prior to acquiring the first position information of the target object in the scene to be rendered in the screen, acquire relevant information of the scene to be rendered. And the determination module is configured to, based on the relevant information, determine a rendering strategy to be used when rendering the scene to be rendered. Wherein the rendering strategy comprises a strategy of rendering N×M pixel points at a time for at least one object in the scene to be rendered, the at least one object comprises the target object.

Optionally, the relevant information comprises characteristic information of a mapping of the scene to be rendered. Wherein the characteristic information comprises at least one of the following: gradient information of the mapping, or content information of the mapping.

Optionally, the characteristic information comprises the gradient information of the mapping. The determination module is specifically configured to, in a case that the gradient information of the mapping is within a target gradient range, determine that a rendering strategy corresponding to the target gradient range is used when rendering the scene to be rendered.

Optionally, the characteristic information comprises the content information of the mapping. The determination module is specifically configured to, in a case that the content information of the mapping indicates that the mapping is a target content, determine that a rendering strategy corresponding to the target content is used when rendering the scene to be rendered; or, in a case that the content information of the mapping indicates that the mapping comprises a preset object, determine that a rendering strategy corresponding to the preset object is used for the preset object when rendering the scene to be rendered.

Optionally, the characteristic information further comprises the gradient information of the mapping; the determination module is specifically configured to, in a case that the gradient information of the mapping is within a target preset gradient range and the mapping is the target content, determine that the rendering strategy corresponding to the target content is used when rendering the scene to be rendered; or, the determination module is specifically configured to, in a case that the gradient information of the mapping is within the target preset gradient range and the mapping comprises the preset object, determine that the rendering strategy corresponding to the preset object is used for the preset object when rendering the scene to be rendered.

Optionally, the relevant information comprises parameter information of each object in the scene to be rendered. The parameter information comprises at least one of the following: a number of triangular faces of each object, or depth information of each object after rendering.

Optionally; the parameter information comprises the number of the triangular faces of each object. The determination module is specifically configured to, based on the number of the triangular faces of each object; determine a proportion of objects in the scene to be rendered that satisfy a predetermined condition, wherein the predetermined condition includes that the number of the triangular faces of the object is less than or equal to a number threshold of the triangular faces; and in a case that the proportion is within a target ratio range, determine that a rendering strategy corresponding to the target ratio range is used when rendering the scene to be rendered; or, the determination module is specifically configured to, based on the number of the triangular faces of each object, determine a target number range which comprises the number of the triangular faces of the first object; and determine that a rendering strategy corresponding to the target number range is used for the first object when rendering the scene to be rendered, the first object being any of the objects.

Optionally, the relevant information further comprises characteristic information of a mapping of the scene to be rendered. The characteristic information comprises gradient information of the mapping. The determination module is specifically configured to, in a case that the gradient information of the mapping is within a target preset gradient range determine the proportion of objects that satisfy the predetermined condition in the scene to be rendered, based on the number of the triangular faces of each object; or, the determination module is specifically configured to, in a case that the gradient information of the mapping is within the target preset gradient range, determine the target number range which comprises the number of the triangular faces of the first object, based on the number of the triangular faces of each object.

Optionally, the parameter information comprises the depth information of each object after rendering. The determination module is specifically configured to, based on the depth information of each object after rendering, determine a target depth range to which the depth information of the second object after rendering belongs; and determine that a rendering strategy corresponding to the target depth range is used for the second object when rendering the scene to be rendered. Wherein the second object is any of each object.

Optionally, the relevant information further comprises characteristic information of a mapping of the scene to be rendered. The characteristic information comprises: gradient information of the mapping. And the determination module is specifically configured to, in a case that the gradient information of the mapping is within a target preset gradient range, determine the target depth range to which the depth information of the second object after rendering belongs, based on the depth information of each object after rendering.

In a third aspect of the embodiments of the present disclosure, there is provided an electronic device. The electronic device comprises a processor, a memory and a computer program stored on the memory and runnable on the processor. The computer program, when executed by the processor, implements the object rendering method according to the first aspect.

In a fourth aspect of the embodiments of the present disclosure, there is provided a computer-readable storage medium, having a computer program stored thereon that, when executed by a processor, implements the object rendering method according to the first aspect.

In a fifth aspect of the embodiments of the present disclosure, there is provided a computer program product, wherein the computer program product comprises a computer program that, when run on a processor, causes the processor to execute the computer program to implement the object rendering method according to the first aspect.

In a sixth aspect of the embodiments of the present disclosure, there is provided a chip. The chip comprises a processor and a communication interface coupled to the processor. The processor is configured to run program instructions to implement the object rendering method according to the first aspect.

The technical solution provided in the embodiments disclosed herein has the following advantages over the prior art: in the embodiments disclosed herein, first position information of a target object in a scene to be rendered in a screen is acquired; and, in a case that the first position information indicates that an intersection of the target object and a user gaze area satisfies a preset condition, the target object is rendered based on a first rendering strategy (i.e., a strategy of rendering P×Q pixel points at a time). In this manner, the same rendering strategy can be implemented for the target object whose intersection with the user gaze area satisfies the predetermined condition, thereby avoiding tearing a rendered target object due to the fact that optimized rendering is performed on a scene to be rendered to improve the rendering efficiency and improving the user experience.

### BRIEF DESCRIPTION OF THE DRAWINGS

The accompanying drawings, which are incorporated into and form part of this specification, illustrate embodiments consistent with the present disclosure and are used in conjunction with this specification to explain the principles of the present disclosure.

In order to more clearly explain the technical solutions in the embodiments of the present disclosure or the prior art, the drawings needed to be used in the description of the embodiments or the prior art will be briefly introduced below. Obviously, for those of ordinary skill in the art, other drawings can be obtained based on these drawings without exerting inventive efforts.

FIG. 1 is one of the schematic flowcharts illustrating the object rendering method provided in the embodiments of the present disclosure.

FIG. 2 is another schematic flowchart illustrating the object rendering method provided in the embodiments of the present disclosure.

FIG. 3 is yet another schematic flowchart illustrating the object rendering method provided in the embodiments of the present disclosure.

FIG. 4 is still another schematic flowchart illustrating the object rendering method provided in the embodiments of the present disclosure.

FIG. 5 is a structural block diagram of an object rendering apparatus provided in the embodiments of the present disclosure.

FIG. 6 is a structural block diagram of an electronic device provided in the embodiments of the present disclosure.

### DETAILED DESCRIPTION OF EMBODIMENTS

In order to provide a clearer understanding of the objectives, features, and advantages of the present disclosure, a further description of the solution disclosed herein will be provided below. It should be noted that, unless conflicting, the embodiments and features thereof disclosed in the present disclosure may be combined with each other.

Many specific details are described below to fully understand the present disclosure. However, the present disclosure can be implemented in other ways not described herein. Clearly, the embodiments described in the specification are only part of the embodiments of the present disclosure, not all of them.

The terms “first”, “second”, etc., used in the specification and claims of the present disclosure are used to distinguish similar objects, not to describe a particular order or sequence. It should be understood that such data used can be interchanged where appropriate, so that the embodiments of the present disclosure can be implemented in an order other than that illustrated or described here, and the objects distinguished by “first”, “second”, etc., typically represent a class, and do not limit the number of objects, for example, the first object can be one or more. Furthermore, in the specification and claims, “and/or” indicates at least one of the connected objects, and the character “/” generally indicates a relationship of “or” between associated objects.

The electronic devices in the embodiments of the present disclosure can be mobile electronic devices or non-mobile electronic devices. Mobile electronic devices can be mobile phones, tablets, laptops, handheld computers, car-mounted electronic devices, wearable devices, ultra-mobile personal computers (UMPCs), netbooks, or personal digital assistants (PDAs), etc.; non-mobile electronic devices can be personal computers (PCs), televisions (TVs), ATMs, or kiosks, etc.; the embodiments of the present disclosure do not specifically limit this.

The wearable devices mentioned can be head-mounted devices or wristband devices. Wherein head-mounted devices can include those with virtual reality (VR), augmented reality (AR), or mixed reality (MR) functions, such as VR headsets, VR glasses, VR helmets, AR glasses, AR helmets, MR glasses, MR helmets, etc.; wristband devices can be smart watches, smart bracelets, etc.; the specific type may be determined according to actual circumstances, and the embodiments of the present disclosure do not limit this.

The execution subject of the object rendering method provided in the embodiments of the present disclosure can be the above electronic devices (including mobile electronic devices and non-mobile electronic devices), or functional modules and/or functional entities in the electronic device capable of implementing the object rendering method. The specific implementation can be determined according to actual usage requirements, and the embodiments of the present disclosure do not limit this.

The object rendering method provided by the embodiments of the present disclosure will be described in detail below in conjunction with the accompanying drawings through specific embodiments and their application scenarios.

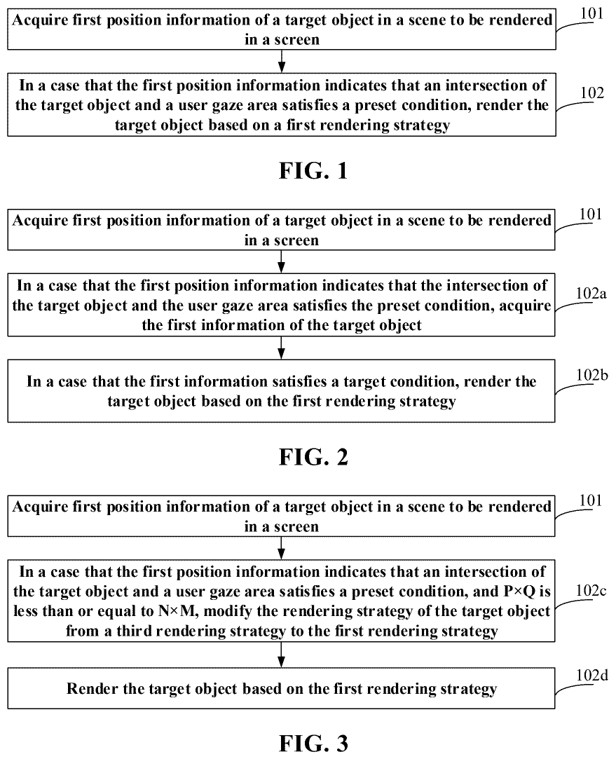

As shown in FIG. 1, the embodiments of the present disclosure provide an object rendering method, which may comprise the following steps 101 to step 102.

Step 101: first position information of a target object in a scene to be rendered in a screen is acquired.

Wherein the first position information is used to indicate the position of the target object. Optionally, the first position information may indicate any of the following: the position where the center point of the target object is located, or the position of the outline of the target object. The first position information may further be used to indicate other positions on the target object, and the embodiments of the present disclosure do not limit this.

Step 102: in a case that the first position information indicates that an intersection of the target object and a user gaze area satisfies a preset condition, the target object is rendered based on a first rendering strategy.

Wherein the first rendering strategy is a strategy of rendering P×Q pixel points at a time, and P and Q are positive integers.

It should be noted that in the embodiments of the present disclosure, P×Q pixel points refer to a pixel area of P rows and Q columns. P×Q pixels may also indicate the resolution of the object after rendering. The larger the P×Q, the smaller the resolution of the object after rendering; and the smaller the P×Q, the larger the resolution of the object after rendering.

Wherein P×Q may be 1×1, 1×2, 2×1, 2×2, 1×3, 3×1, 2×3, 3×3, 1×4, 4×1, 2×4, 4×2, 3×4, 4×3, 4×4, 5×5, 6×6, 8×8, etc. The specific values may be determined according to actual circumstances, and the embodiments of the present disclosure do not limit this.

Wherein in the embodiments of the present disclosure, the rendering strategy may be VRS or other rendering strategies that can improve rendering speed. The specific rendering strategy may be determined according to actual circumstances, and the embodiments of the present disclosure do not limit this.

Optionally, the user gaze area may be determined by eye tracking methods, such as determining the user gaze point by eye tracking methods and using the user gaze point as the center with the first length as the radius, to determine the gaze area. The eye tracking method may be determined according to actual circumstances, and is not limited herein.

Optionally, the user gaze area may be a preset area, that is, the user gaze area is a fixed area on the screen.

Optionally, the first position information is used to indicate the position where the center point of the target object is located. Step 101 mentioned above may be to first acquire the outline information of the target object, and then determine the first position information where the center point of the target object is located based on the outline information of the target object. The method of acquiring the outline information of the target object may refer to relevant technologies, and is not limited herein.

Optionally, the first position information is used to indicate the position where the center point of the target object is located. Step 101 mentioned above may also acquiring the first position information where the center point of the target object is located, by a bounding box determination method. The shape of the bounding box may be determined according to actual usage requirements, and is not limited herein.

For example, if the bounding box is a cube, at least 8 points on the outline of the target object may be acquired through the bounding box determination method, and then the position (coordinates) of the center point may be determined through the at least 8 points to acquire the first position information.

It can be understood that if the first position information is used to indicate the position of the center point of the target object, then the preset condition may be that the center point of the target object is located within the user gaze area.

Optionally, the first position information is used to indicate the outline position of the target object, that is, the first information is the outline information of the target object, and step 101 mentioned above may be acquiring the outline information of the target object.

It can be understood that if the first position information is used to indicate the outline position of the target object, the preset condition may be that the proportion of the intersection between the target object and the user gaze area in the target object is greater than or equal to a preset ratio threshold. Wherein the preset ratio threshold may be 0 or any value less than 1. The specific preset ratio threshold may be determined according to actual conditions, and is not limited herein.

In the embodiments of the present disclosure, by acquiring first position information of a target object in a scene to be rendered in a screen, and in a case that the first position information indicates that an intersection of the target object and a user gaze area satisfies a preset condition, rendering the target object based on a first rendering strategy, the same rendering strategy can be implemented for the target object whose intersection with the user gaze area satisfies the predetermined condition, thereby avoiding tearing a rendered target object due to the fact that optimized rendering is performed on a scene to be rendered to improve the rendering efficiency and improving the user experience.

Optionally, the object rendering method provided in the embodiments of the present disclosure may further comprise the following step 103.

Step 103: in a case that the first position information indicates that an intersection of the target object and a user gaze area does not satisfy a preset condition, rendering the target object based on the fourth rendering strategy.

Wherein the fourth rendering strategy may comprise at least one rendering strategy, and the resolution of the target object rendered by any rendering strategy of the fourth rendering strategy is lower than that rendered by the first rendering strategy. The fourth rendering strategy may be a rendering strategy determined by analyzing the scene to be rendered before step 101, a preset rendering strategy, or a previous default rendering strategy of the scene to be rendered, which may be determined according to the actual situation, and is not limited herein.

Optionally, in conjunction with FIG. 1, as shown in FIG. 2, the above step 102 may specifically be implemented through the following steps 102a to 102b.

Step 102a: in a case that the first position information indicates that the intersection of the target object and the user gaze area satisfies the preset condition, the first information of the target object is acquired.

Optionally, the first information comprises at least one of the following: the first depth value of the target object after rendering, the first size value of the target object, the gradient information of the mapping region, the type of the target object, and the number of the triangular faces of the target object. The first information may also comprise other information, which can be determined according to specific circumstances, and is not limited herein.

Wherein the mapping region is a region of the target object in the mapping corresponding to the scene to be rendered.

Step 102b: in a case that the first information satisfies a target condition, the target object is rendered based on the first rendering strategy.

In the embodiments of the present disclosure, it is possible to better determine whether to render the target object based on the first rendering strategy according to whether the first information satisfies the target condition.

Optionally, in a case that the first information comprises a first depth value of the target object after rendering, the target condition comprises that the first depth value is less than or equal to a preset depth threshold.

Wherein the description of the first depth value can refer to the relevant description of the depth information after rendering for each object in the following step 201d, which is not limited herein. The preset depth threshold may be determined according to actual conditions, which is not limited herein.

In the embodiments of the present disclosure, since objects with a larger depth value end up with a smaller display size on the screen, they are usually not objects of interest to the user and do not need to be displayed in high definition. Therefore, if the first depth value is large, even if the resolution of the rendered target object is low or there are multiple resolutions, etc., the user experience will not be affected, and thus flexible rendering of the target object can be realized.

Optionally, in a case that the first information comprises a first size value of the target object, the target condition comprises that the first size value is greater than or equal to a preset size threshold.

Wherein the preset size threshold may be determined according to actual conditions, which is not limited herein.

Wherein the first size value is used to indicate the size of the area on the screen that the target object will occupy after projection, which can be obtained by a bounding box determination method; or it is also possible to determine the outline information of the target object first, and acquire the first size value based on the outline information of the target object; the first size value may further be acquired through other methods, which can be specifically determined according to the actual situation, and is not limited herein.

In the embodiments of the present disclosure, small-sized objects are usually not objects of interest to the user and do not need to be displayed in high definition. Therefore, if the first size value is small, even if the resolution of the rendered target object is low or there are multiple resolutions, etc., the user experience will not be affected, and thus flexible rendering of the target object can be realized.

Optionally, in a case that the first information comprises gradient information of a mapping region, the target condition comprises that the gradient information of the mapping region is greater than or equal to a preset gradient threshold, and the mapping region is a region of the target object in a mapping corresponding to the scene to be rendered.

Wherein the description of the gradient information of the mapping region may refer to the relevant description of the gradient information of the mapping in the following step 201b, which is not limited herein.

Wherein the preset gradient threshold may be determined according to actual conditions, which is not limited herein.

In the embodiments of the present disclosure, since objects with small gradient information indicate that the content of the objects changes slowly, they are usually not objects of interest to the user and do not need to be displayed in high definition. Therefore, if the gradient information of the mapping region is small, even if the resolution of the rendered target object is low or there are multiple resolutions, etc., the user experience will not be affected, and thus flexible rendering of the target object can be realized.

Optionally, in a case that the first information comprises a type of the target object, the target condition comprises that the type of the target object is a preset type.

Wherein the type of the object may include human, animal, plant, building, etc., which can be determined according to actual conditions, and is not limited herein. The preset type may also be determined according to actual conditions, which is not limited herein.

In the embodiments of the present disclosure, the preset type is a type of interest to the user and needs to be displayed in high definition, while objects that are not the type of interest to the user do not need to be displayed in high definition. Therefore, if the type of the target object is not the preset type, even if the resolution of the rendered target object is low or there are multiple resolutions, etc., the user experience will not be affected, and thus flexible rendering of the target object can be realized.

Optionally, in a case that the first information comprises a number of triangular faces of the target object, the target condition comprises that the number of the triangular faces of the target object is greater than or equal to a preset number threshold.

Wherein the preset number threshold may be determined according to actual conditions, which is not limited herein.

Wherein the description of the number of the triangular faces of the target object may refer to the relevant description of the number of the triangular faces of each object in the following step 201b, which is not limited herein.

In the embodiments of the present disclosure, when the number of the triangular faces of objects is small, the objects are usually not objects of interest to the user and do not need to be displayed in high definition. Therefore, if the number of the triangular faces of the target object is small, even if the resolution of the rendered target object is low or there are multiple resolutions, etc., the user experience will not be affected, and thus flexible rendering of the target object can be realized.

In the embodiments of the present disclosure, a variety of first information may be set to make the rendering of the target object more reasonable.

It can be understood that in conjunction with the above steps 102a to 102b, after the above step 102, the object rendering method provided in the embodiments of the present disclosure may further comprise the following step 104.

Step 104: in a case that the first position information indicates that an intersection of the target object and a user gaze area satisfies a preset condition, but the first information does not satisfy the target condition, the target object is rendered based on the fourth rendering strategy.

Wherein the description of the fourth rendering strategy may refer to the relevant description of the fourth rendering strategy in the above step 103, which is not repeated herein.

Optionally, before the above step 102, the object rendering method provided in the embodiments of the present disclosure may further comprise the following step 105.

Step 105: it is determined that rendering strategies set for the target object comprises a first rendering strategy and a second rendering strategy.

Wherein the second rendering strategy is a strategy of rendering S×T pixel points at a time, P×Q is less than S×T, and S and T are positive integers.

Wherein the description of S×T may refer to the relevant description of P×Q in the above step 102, which is not repeated herein.

Optionally, the first rendering strategy and the second rendering strategy may be rendering strategies set based on methods involved in background technology.

Wherein in addition to the first rendering strategy and the second rendering strategy, the rendering strategy set for the target object may further comprise other rendering strategies, which is not limited herein.

It can be understood that if the target object is rendered according to the first rendering strategy and the second rendering strategy, the rendered target object will give a sense of tearing. Therefore, the embodiments of the present disclosure can avoid tear a rendered target object, and improve the user experience.

Optionally, in conjunction with FIG. 1, as illustrated in FIG. 3, the above step 102 may specifically be implemented through the following steps 102c and 102d.

Step 102c: in a case that the first position information indicates that an intersection of the target object and a user gaze area satisfies a preset condition, and P×Q is less than or equal to N×M, the rendering strategy of the target object is modified from a third rendering strategy to the first rendering strategy.

Step 102d: the target object is rendered based on the first rendering strategy.

Optionally, the object rendering method provided in the present disclosure may further comprise, in a case that P×Q is greater than N×M, rendering the target object based on the third rendering strategy.

Wherein the description of N×M may refer to the relevant description of P×Q in the above step 102, which is not repeated herein.

It can be understood that the third rendering strategy is the rendering strategy set for the target object before step 101; if P×Q is less than or equal to N×M, rendering the first object through the first rendering strategy can make the resolution of the target object higher, thereby improving the user experience; if P×Q is greater than N×M, rendering the first object through the third rendering strategy can make the resolution of the target object higher, thereby improving the user experience.

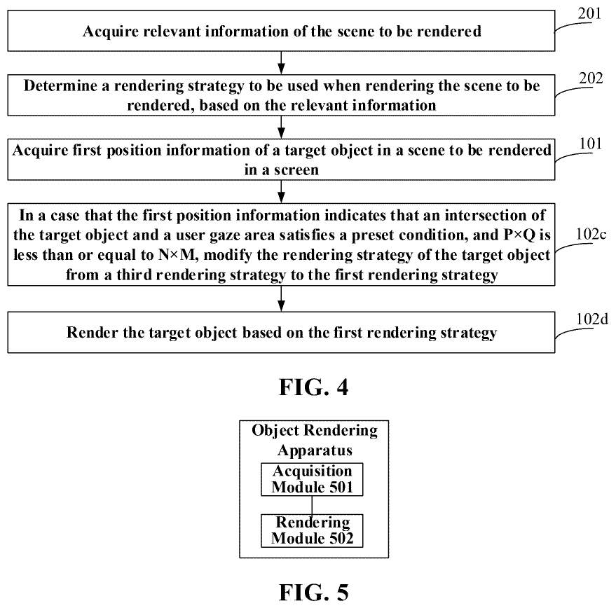

Optionally, in conjunction with FIG. 3, as illustrated in FIG. 4, before the above step

101, the object rendering method provided in the present disclosure may further comprise the following steps 201 to 202.

Step 201: relevant information of the scene to be rendered is acquired.

In the embodiments of the present disclosure, the relevant information may be information of objects in the scene to be rendered, or information of the mapping of the scene to be rendered, which can be determined according to actual conditions, and is not limited herein.

Step 202: a rendering strategy adopted when rendering the scene to be rendered is determined based on the relevant information.

Wherein the rendering strategy comprises a strategy of rendering N×M pixel points at a time for at least one object in the scene to be rendered (i.e., the third rendering strategy, at this time, the third rendering strategy is determined based on the relevant information of the scene to be rendered), the at least one object comprising the target object (i.e., a third rendering strategy is determined to be used to the target object in rendering the scene to be rendered based on relevant information about the scene to be rendered).

It can be understood that, based on the relevant information, when rendering the scene to be rendered, a strategy of rendering N×M pixel points at a time may be used to all objects in the entire scene to be rendered; alternatively, a strategy of rendering N×M pixel points at a time may be used to some objects in the scene to be rendered; or a strategy of rendering different numbers of pixel points at a time may be used to different objects in the scene to be rendered (i.e., as to some objects, a strategy of rendering N1×M1 pixel points at a time is used, while as to some other objects, a strategy of rendering N2×M2 pixel points at a time is used, where N1 and N2 are different, and M1 and M2 are different). The specific setting can be determined according to actual usage conditions, and the embodiments of the present disclosure do not limit this.

It should be noted that in the embodiments of the present disclosure, the rendering strategy for the scene to be rendered may be determined before rendering the scene to be rendered. Therefore, the processes from the above step 201 to step 202 in the embodiments of the present disclosure may be implemented during the application loading phase, which can simplify the determination process of the rendering strategy for the scene to be rendered during rendering, and will not compete with rendering tasks for computing resources in the device, thus improving rendering speed.

In the embodiments of the present disclosure, based on the relevant information of the scene to be rendered, it may be flexibly determined whether or not to use the strategy of rendering at least one pixel at a time for at least one object in the scene to be rendered, so that the purpose of improving the rendering speed may be flexibly realized according to the actual situation of the scene to be rendered, thereby saving the computational power of the graphics processor and reducing the load pressure of the graphics processor.

Optionally, the relevant information comprises characteristic information of the mapping of the scene to be rendered. Wherein the characteristic information comprises at least one of the following: gradient information of the mapping, or content information of the mapping.

Exemplarily, the above step 201 may specifically be implemented through the following steps 201a to 201b.

Step 201a: the mapping of the scene to be rendered is acquired.

Mapping is a step of the production process of 3D film and animation as well as game production, that is, the process of using graphic software such as image processing software (Adobe Photoshop, PS) to create a texture plan and overlaying it on a three-dimensional model created using 3D production software such as Maya and 3DMax is called mapping.

Wherein mapping can reflect the surface reflection and surface color of objects in the scene to be rendered. For example, when the scene to be rendered is a game scene, mapping can reflect the surface reflection and surface color of objects in the game scene.

In the embodiments of the present disclosure, the mapping of the scene to be rendered may be acquired at the system level using a hook method.

The hook method may include invoking an existing hook code (hook tool), or may include modifying the relevant code to obtain a hook code. The specific method may be determined according to the actual situation, and the embodiments of the present disclosure do not limit this.

Exemplarily, at the system level, by hooking into a load mapping function of the OpenGL for Embedded Systems (OpenGL ES), all the mappings given to OpenGL ES by the application may be acquired.

Exemplarily, in the process of the application sending the mapping of the scene to be rendered saved inside the application APK to the graphics processor by invoking the system interface, the mapping of the scene to be rendered is acquired at the system level by the hook method.

In the embodiments of the present disclosure, the idea of hook is used to transparently optimize the application, so that the application designer can add new functions to the application without changing the existing functions of the application.

Step 201b: the characteristic information of the mapping is determined as the relevant information.

Optionally, the characteristic information comprises gradient information of the mapping. The mapping may be input into a pre-trained machine learning gradient model to output the gradient information of the mapping. Alternatively, the gradient information of the grayscale in the x-direction and the gradient information of the grayscale in the y-direction of the mapping may also be directly calculated through digital image processing methods, and then the gradient information of the mapping may be obtained.

Optionally, the gradient information of the grayscale in the x-direction of the mapping may be the sum of the absolute values of the differences between the grayscale values of consecutive pixel points in each row; and the gradient information of the grayscale in the y-direction thereof may be the sum of the absolute values of the differences between the grayscale values of consecutive pixel points in each column. The gradient information of the grayscale in the x-direction and the gradient information of the grayscale in the y-direction of the mapping may also be calculated by other algorithms. The specific algorithm may be determined according to the actual situation, and are not limited herein. The gradient information of the mapping may be the sum of the gradient information of the grayscale in the x-direction and the gradient information of the grayscale in the y-direction, and it may also be the arithmetic square root of the square sum of the gradient information of the grayscale in the x-direction and the gradient information of the grayscale in the y-direction. The gradient information of the mapping may also be calculated by other formulas, which can be determined according to the actual situation, and is not limited herein.

Wherein the machine learning gradient model may be obtained by training the machine learning model based on the gradient sample data. The machine learning model may be a basic model established based on any machine learning algorithm. The gradient sample data includes a large number of gradient samples, and each gradient sample includes a mapping and a gradient corresponding to the mapping. The specific training process of the machine learning gradient model may refer to existing related technologies, and is not limited herein.

In the embodiments of the present disclosure, the machine learning gradient model is combined to maximize the capabilities of the graphics processor and squeeze out more computational power without interfering with the rendering process.

Wherein the gradient information of the mapping is used to characterize the gradient changes of the mapping. Usually, the less the gradient information of the mapping, the gentler the gradient change of the mapping, and the larger the gradient information of the mapping. the more dramatic the gradient change of the mapping. When the color change of the mapping is not obvious, the gradient information of the mapping is small, and when the content change of the mapping is not obvious, the gradient information of the mapping is small. When the gradient information of the mapping is small, a strategy of rendering multiple pixel points at a time may be used for at least one object in the scene to be rendered corresponding to the mapping (i.e., a rendering strategy), to increase the rendering speed, save the computational power of the graphics processor, and reduce the workload of the graphics processor.

Optionally, the characteristic information comprises gradient information of the mapping; the above step 202 may be specifically implemented through the following step 202a.

Step 202a: in a case that the gradient information of the mapping is within a target gradient range, a rendering strategy corresponding to the target gradient range adopted when rendering the scene to be rendered is determined.

Wherein the target gradient range may be determined according to actual usage requirements, the rendering strategy corresponding to the target gradient range may be determined according to actual conditions, and the embodiments of the present disclosure do not limit this.

It can be understood that multiple gradient ranges may be set (where the target gradient range is any of the multiple gradient ranges), different gradient ranges correspond to different rendering strategies, and different rendering strategies correspond to different N×M.

Exemplarily, if the multiple gradient ranges are a first gradient range, a second gradient range, and a third gradient range, wherein any of the gradient information in the first gradient range is less than any of the gradient information in the second gradient range, any of the gradient information in the second gradient range is less than any of the gradient information in the third gradient range, the N×M corresponding to the first gradient range is 4×4, the N×M corresponding to the second gradient range is 2×2, and the N×M corresponding to the third gradient range is 1×1. If the gradient information of the mapping is within the first gradient range, it is determined to use a strategy of rendering 4×4 pixel points at a time when rendering the scene to be rendered. If the gradient information of the mapping is within the second gradient range, it is determined to use a strategy of rendering 2×2 pixel points at a time when rendering the scene to be rendered. If the gradient information of the mapping is within the third gradient range, it is determined to use a strategy of rendering 1×1 pixel point at a time when rendering the scene to be rendered.

In the embodiments of the present disclosure, according to the gradient information of the mapping of the scene to be rendered, the rendering strategy used to render the scene to be rendered can be determined, and it can be flexibly determined whether to use a strategy of rendering multiple pixel points at a time for the scene to be rendered.

Optionally, the characteristic information may be content information of the mapping. The mapping may be input into a pre-trained machine learning recognition model that outputs content information recognized from the mapping. Alternatively, the content information in the mapping may be recognized by an object recognition algorithm, and then, based on the recognized content information, the rendering strategy adopted in rendering the scene to be rendered may be determined.

Wherein the machine learning recognition model may be obtained by training the machine learning model based on the recognition sample data. The machine learning model may be a basic model based on any machine learning algorithm. The recognition sample data includes a large number of recognition samples, and each recognition sample includes a mapping and content information corresponding to the mapping. The specific training process of the machine learning recognition model may refer to existing related technologies, and is not limited herein.

In the embodiments of the present disclosure, the machine learning recognition model is combined to maximize the capabilities of the graphics processor and squeeze out more computing power without interfering with the rendering process.

Wherein the object recognition algorithm may be determined according to actual conditions, and the embodiments of the present disclosure do not limit this.

Optionally, the characteristic information comprises content information of the mapping. The above step 202 may be implemented through the following step 202b or step 202c.

Step 202b: in a case that the content information of the mapping indicates that the mapping is the target content, a rendering strategy corresponding to the target content.

Optionally, the target content is any of at least one preset content. Different preset contents may be set to correspond to different rendering strategies, and different rendering strategies correspond to different N×M. Alternatively different preset contents may also be set to correspond to the same rendering strategy. It can specifically be determined according to the actual situation, and is not limited herein.

It can be understood that in a case that the content information of the mapping indicates that the mapping is the target content, it is determined that the rendering strategy corresponding to the target content is used for the target content, and other rendering strategies are used for the content other than at least one preset content, when rendering the scene to be rendered.

Optionally, each of the preset contents may be grass, leaves, stones, or other content that is not of interest, and may be specifically determined according to the actual situation, and the embodiments of the present disclosure do not limit this. The rendering strategy corresponding to each preset content may be a rendering strategy other than the strategy of rendering 1×1 pixel point (i.e., the M×N of the rendering strategy corresponding to the target content is not 1×1) at a time. In this way, when rendering the scene to be rendered, a rendering optimization strategy may be used for the target content that is not of interest (i.e., a strategy of rendering multiple pixel points at a time), to increase the rendering speed, save the computational power of the graphics processor, and reduce the workload of the graphics processor.

It can be understood that if the content information of the mapping indicates that the mapping is the target content (where the target content is any of at least one preset content), it is determined to use the rendering strategy corresponding to the target content when rendering the scene to be rendered. If the content information of the mapping indicates that the mapping is not any of the at least one preset content, it is determined to use a strategy of rendering 1×1 pixel point at a time when rendering the scene to be rendered.

Exemplarily, different preset contents correspond to different rendering strategies. The first preset content is grass, with a corresponding N×M being 4×4, and the second preset content is stone, with a corresponding N×M being 2×4. When the content information of the mapping indicates anything other than the first or second target content, N×M is 1×1. In other words, if the content information of the mapping indicates that the mapping is grass, it is determined to use a rendering strategy of rendering 4×4 pixel points at a time when rendering the scene to be rendered. If the content information of the mapping indicates that the mapping is stone, it is determined to use a rendering strategy of rendering 2×4 pixel points at a time when rendering the scene to be rendered. If the content information of the mapping indicates that the mapping is neither grass nor stones, it is determined to use a rendering strategy of rendering 1×1 pixel point at a time when rendering the scene to be rendered.

Optionally, each of the preset contents may be a content that includes objects of interest such as people, animals, etc., which may be specifically determined according to the actual situation, and the embodiments of the present disclosure do not limit this. The rendering strategy corresponding to each of the preset contents may be a strategy of rendering 1×1 pixel point (i.e., the M×N of the rendering strategy corresponding to the target content is 1×1) at a time. In this way, when rendering the scene to be rendered, a strategy of rendering 1×1 pixel point at a time may be used to the target content of interest, which will not reduce the resolution of the content of interest and can improve the user experience.

It can be understood that if the content information of the mapping indicates that the mapping is a target content (where the target content is at least one of the preset contents), it is determined to use a strategy of rendering 1×1 pixel point at a time when rendering the scene to be rendered. If the content information of the mapping indicates that the mapping is not any of the preset contents, it is determined to use a rendering strategy other than the strategy of rendering 1×1 pixel point at a time when rendering the scene to be rendered (for example, a strategy of rendering 2×2 pixel points at a time).

Exemplarily, the N×M of the rendering strategy corresponding to each of the preset contents is set as 1×1, while the N×M of the rendering strategy corresponding to content other than the at least one of the preset contents is set as 4×4. In other words, if the content information of the mapping indicates that the mapping is a target content (where the target content is any of the preset contents), it is determined to use a strategy of rendering 1 ×1 pixel point at a time when rendering the scene to be rendered. If the content information of the mapping indicates that the mapping is not any of the preset contents, it is determined to use a strategy of rendering 4×4 pixel points at a time when rendering the scene to be rendered.

In the embodiment of the present disclosure, the content information of the mapping indicates that the mapping is the target content, which is considered from the overall perspective of the mapping. When the entire mapping is the target content, it is determined to use the rendering strategy corresponding to the target content when rendering the scene to be rendered. When the entire mapping is not any of the preset contents (i.e., any of the at least one preset content), it is determined to use other rendering strategies when rendering the scene to be rendered. In this way, the rendering strategy adopted when rendering the scene to be rendered may be flexibly determined, and thus when rendering the scene to be rendered, a strategy of rendering multiple pixel points at a time may be used, which can increase the rendering speed.

Step 202c: in a case that the content information of the mapping indicates that the mapping comprises a preset object, it is determined that a rendering strategy corresponding to the preset object is used for the preset object when rendering the scene to be rendered.

Optionally, the preset object may be any of at least one preset object, and different preset objects may be set to correspond to different rendering strategies which correspond to different N×M. Alternatively, different preset objects may be set to correspond to the same rendering strategy. It can be specifically determined according to the actual situation, and is not limited herein.

Optionally, each of the preset objects may be an object that is not of interest, such as grass, stones, or large trees, and may be specifically determined according to the actual situation, and the embodiments of the present disclosure do not limit this. The rendering strategy corresponding to each of the preset objects may be a rendering strategy other than the strategy of rendering 1×1 pixel point (i.e., the M×N for the rendering strategy corresponding to the preset object is not 1×1) at a time. Thus, during rendering of the scene to be rendered, a rendering optimization strategy (i.e., a strategy of rendering multiple pixel points at a time) may be used to the preset objects not of interest, to increase the rendering speed, save the computational power of the graphics processor, and reduce the workload of the graphics processor.

It can be understood that if the content information of the mapping indicates that the mapping includes a preset object, when it is determined to render the scene to be rendered, the rendering strategy corresponding to the preset object is used for the preset object, and a strategy of rendering 1×1 pixel point at a time is used for objects other than the at least one preset object.

Exemplarily, different preset objects are set to correspond to different rendering strategies. The first preset object is grass, with a corresponding N×M being 4×4, while the second preset object is stone, with a corresponding N×M being 2×4. In other words, if the content information of the mapping indicates that the mapping includes grass and stone, it is determined that when rendering the scene to be rendered, a strategy of rendering 4×4 pixel points at a time is used to the grass, and a strategy of rendering 2×4 pixel points at a time is used to the stones, while a strategy of rendering 1×1 pixel point at a time is used to objects other than grass and stones.

Optionally, each of the preset objects may also be an object of interest such as people, animals, etc., which may be specifically determined according to the actual situation, and the embodiments of the present disclosure do not limit this. The rendering strategy corresponding to each of the preset objects may be a strategy of rendering 1×1 pixel point (i.e., the M×N of the rendering strategy corresponding to the preset object is 1×1) at a time. In this way, when rendering the scene to be rendered, a strategy of rendering 1×1 pixel point at a time may be used to the preset object of interest, which will not reduce the resolution of the object of interest and can improve the user experience.

It can be understood that if the content information of the mapping indicates that the mapping includes a preset object (which is any of at least one preset object), it is determined to use a strategy of rendering 1×1 pixel point at a time for the preset object when rendering the scene to be rendered, and use a rendering strategy (for example, a strategy of rendering 2×2 pixel points at a time) other than the strategy of rendering 1×1 pixel point at a time for objects other than the at least one preset object (in the scene to be rendered).

Exemplarily; the N×M of the rendering strategy corresponding to each of the preset objects is set as 1×1, while the N×M of the rendering strategy corresponding to objects other than the at least one preset object is set as 4×4. In other words, if the content information of the mapping indicates that the mapping includes the preset object, it is determined to use a strategy of rendering 1×1 pixel point at a time for the preset object when rendering the scene to be rendered, and use a strategy of rendering 4×4 pixel points at a time for objects other than the at least one preset object in the scene to be rendered.

In the embodiment of the present disclosure, the content information of the mapping indicates that the mapping includes a preset object, which is considered from a local perspective of the mapping. When a part of the mapping is a preset object, it is determined to use a rendering strategy corresponding to the preset object, and use other rendering strategies to objects in the scene to be rendered other than the preset object when rendering the scene to be rendered (if the content information of the mapping indicates the mapping does not include any preset object (any of the at least one preset object), it is determined to use other rendering strategies when rendering the scene to be rendered). In this way, the rendering strategy used for rendering the scene to be rendered may be flexibly determined, and different rendering strategies may be used for different objects (different local regions), and thus when rendering the scene to be rendered, a strategy of rendering multiple pixel points at a time may be used locally, which can improve the rendering speed.

Optionally, the characteristic information further comprises the gradient information of the mapping, and the above step 202b can be specifically implemented through the following step 202b1.

Step 202b1: in a case that the gradient information of the mapping is within the target preset gradient range and the mapping is the target content, it is determined that a rendering strategy corresponding to the target content is used when rendering the scene to be rendered.

It can be understood that in the embodiments of the present disclosure, it may first be determined whether the gradient information of the mapping is within the target preset gradient range. If it is within the target preset gradient range, a rendering strategy corresponding to the target content is determined to be used for rendering the scene to be rendered, in a case that the mapping is the target content.

Wherein the description of the target preset gradient range can be referred to the relevant description of the target gradient range in the above step 202a, and will not be repeated here. It can be understood that different gradient ranges may correspond to different rendering strategies when the mapping is the target content, and specifically may be determined according to actual usage requirements.

Exemplarily, a preset gradient range is set, i.e., a range in which any of the values in the target preset gradient range is less than or equal to a gradient threshold. In other words, if the gradient information of the mapping is in the target preset gradient range, a rendering strategy corresponding to the target content is considered to be determined for rendering the scene to be rendered in a case that the mapping is the target content. If the gradient information of the mapping is not in the target preset gradient range, it is unnecessary to consider whether the mapping is the target content, and it is determined to use a preset rendering strategy when rendering the scene to be rendered, and the preset rendering strategy may be determined according to the actual situation, and is not limited herein.

Exemplarily, multiple preset gradient ranges are set, and the target preset gradient range is one of the multiple preset gradient ranges. For example, three preset gradient ranges are set, a first preset gradient range, a second preset gradient range (i.e., a target preset gradient range) and a third preset gradient range. Wherein any of the gradient information in the first preset gradient range is less than any of the gradient information in the second preset gradient range, and any of the gradient information in the second preset gradient range is less than any of the gradient information in the third preset gradient range. When the gradient information of the mapping is within the first preset gradient range, it can be determined that the rendering strategy corresponding to the first preset gradient range is used when rendering the scene to be rendered. When the gradient information of the mapping is within the second preset gradient range, and in a case that the mapping is the target content, it is determined to use the rendering strategy corresponding to the target content when rendering the scene to be rendered; otherwise, it is determined to use the preset rendering strategy when rendering the scene to be rendered. When the gradient information of the mapping is within the third preset gradient range, it can be determined that the preset rendering strategy is used when rendering the scene to be rendered.

In the embodiments of the present disclosure, in conjunction with the gradient information of the mapping and the content information of the mapping, a suitable rendering strategy may be better determined for the scene to be rendered and the rendering speed may be improved.

Optionally, the characteristic information further comprises the gradient information of the mapping. The above step 202c may be specifically implemented through the following step 202c1.

Step 202c1: in a case that the gradient information of the mapping is within the target preset gradient range and the mapping comprises the preset object, it is determined that a rendering strategy corresponding to the preset object is used for the preset object when rendering the scene to be rendered.

Wherein the specific description of step 202c1 may be referred to the relevant description of steps 202c as well as 202b1 above, and will not be repeated herein.

In the embodiments of the present disclosure, in conjunction with the gradient information of the mapping and the content information of the mapping, a suitable rendering strategy may be better determined for the scene to be rendered and the rendering speed may be improved.

Optionally, the relevant information comprises parameter information of each object in the scene to be rendered. Wherein the parameter information comprises at least one of the following: a number of triangular faces of each object, or depth information of each object after rendering.

Exemplarily, the above step 201 may be specifically implemented by the following steps 201c to step 201d.

Step 201c: parameter information of each object in the scene to be rendered is acquired.

Step 201d: the parameter information of each object is determined as the relevant information.

Optionally, the parameter information comprises the number of the triangular faces of each object. The number of the triangular faces of each object may be analyzed based on the vertex upload function of each object in the scene to be rendered (e.g., the vertex upload function of hookOpenGLES). The number of the triangular faces of each object is determined as the relevant information. The number of the triangular faces of each object may also be acquired through other methods. The specific method can be determined according to the actual situation, which is not limited herein. Furthermore, the rendering strategy used when rendering the scene to be rendered can be determined based on the number of the triangular faces of each object.

Optionally, the parameter information comprises the depth information of each object after rendering. A pre-rendering (a simulated rendering) of the scene to be rendered may be performed prior to rendering the scene to be rendered, to obtain the depth information of each object after rendering in the scene to be rendered. The depth information of each object after rendering in the scene to be rendered may also be saved after the scene to be rendered is previously rendered. At the time, the depth information of each object after rendering in the scene to be rendered may be acquired by acquiring the previously saved depth information of each object after rendering in the scene to be rendered. The depth information of each object after rendering may also be acquired by other methods, which may be determined in accordance with the actual situation, and is not limited herein. Further, the rendering strategy used in rendering the scene to be rendered may be determined based on the depth information of each object after rendering.

Optionally, the rendering strategy may not be determined prior to rendering the scene to be rendered for the first time, and a strategy of rendering 1×1 pixel points at a time may be used by default. It is also possible to acquire the depth information of each object after rendering by way of pre-rendering prior to rendering the scene to be rendered for the first time, and to determine the rendering strategy to be used for rendering the scene to be rendered, based on the depth information of each object after rendering. Then, after the scene to be rendered is rendered according to the determined rendering strategy, the depth information of each object after rendering is saved. And thus, before the next rendering of the scene to be rendered, the previously saved depth information for each object may be acquired. Then, based on the depth information of each object after rendering, a rendering strategy used for rendering the scene to be rendered is determined, and then the depth information of each object after rendering is updated after rendering the scene to be rendered based on the determined rendering strategy.

It should be noted that in the embodiments of the present disclosure, the rendering strategy used in rendering the scene to be rendered may also be determined in conjunction with the number of the triangular faces of each object and the depth information of each object after rendering. At the time, if the rendering strategy determined based on the number of the triangular faces of each object is the same as the rendering strategy determined based on the depth information of each object after rendering, or, if the product of N and M corresponding to the rendering strategy determined based on the number of the triangular faces of each object is the same as the product of N and M corresponding to the rendering strategy determined based on the depth information of each object after rendering, the finally determined rendering strategy is the rendering strategy determined based on the number of the triangular faces of each object (or the rendering strategy determined based on the depth information of each object after rendering). If the product of N and M corresponding to the rendering strategy determined based on the number of the triangular faces of each object is not the same as the product of N and M corresponding to the rendering strategy determined based on the depth information of each object after rendering, the finally determined rendering strategy may be either a rendering strategy with the minimum product of N and M, or a rendering strategy with the maximum product of N and M. Specifically, the rendering strategy may be determined according to the actual situation, and the embodiments of the present disclosure do not limit this.

In the embodiments of the present disclosure, the parameter information of each object in the scene to be rendered is determined as the relevant information, which is the number of the triangular faces of each object, and/or, the depth information of each object after rendering, so that the appropriate relevant information may be determined according to the actual situation, and thus the appropriate rendering strategy may be determined.

Optionally, the parameter information comprises the number of the triangular faces of each object. The above step 202 may be specifically implemented through the following steps 202d to step 202e.

Step 202d: the proportion of objects that satisfy the predetermined condition in the scene to be rendered is determined, based on the number of the triangular faces of each object.

Wherein the predetermined condition includes: the number of the triangular faces of the object is less than or equal to a number threshold of the triangular faces.

It can be understood that the smaller the number of the triangular faces of the object, the simpler and less important the object is, and the less likely it is to be an object of interest. Conversely, the larger the number of the triangular faces of the object, the more complex and more important the object is, and the more likely it is to be an object of interest. Objects with the number of the triangular faces being less than or equal to the number threshold of the triangular faces are simple objects, and objects with the number of the triangular faces being greater than the number threshold of the triangular faces are complex objects.

Wherein the number threshold of the triangular faces may be determined according to actual usage requirements, and the embodiments of the present disclosure do not limit this.

Wherein the proportion of objects that satisfy the predetermined conditions in the scene to be rendered is the ratio of the number of objects that satisfy the predetermined conditions in the scene to be rendered to the total number of objects in the scene to be rendered.

Step 202e: in a case that the proportion is within a target ratio range, it is determined that the rendering strategy corresponding to the target ratio range is used when rendering the scene to be rendered.

Wherein the target ratio range may be determined according to the actual usage requirements, the rendering strategy corresponding to the target ratio range may be determined according to the actual situation, and the embodiments of the present disclosure do not limit this.

It can be understood that multiple ratio ranges may be set (the target ratio range is any of the multiple ratio ranges), different ratio ranges correspond to different rendering strategies, and different rendering strategies correspond to different N×M.

Exemplarily, if the multiple ratio ranges are a first ratio range, a second ratio range, and a third ratio range, wherein any of the ratio values in the first ratio range is greater than any of the ratio values in the second ratio range (where a smaller value in the ratio range indicates that the scene to be rendered corresponding to the ratio range has more objects that are not of interest and fewer objects that are of interest, and a strategy of rendering more pixels at a time may be used for the scene to be rendered corresponding to the ratio range), any of the ratio values in the second ratio range is greater than any of the ratio values in the third ratio range, the N×M corresponding to the first ratio range is 4×4, the N×M corresponding to the second ratio range is 2×2, and the N×M corresponding to the third ratio range is 1×1. If the proportion is within the first ratio range, it is determined to use a strategy of rendering 4×4 pixel points at a time when rendering the scene to be rendered. If the proportion is within the second ratio range, it is determined to use a strategy of rendering 2×2 pixel points at a time when rendering the scene to be rendered. If the proportion is within the third ratio range, it is determined to use a strategy of rendering 1×1 pixel point at a time when rendering the scene to be rendered.

In the embodiments of the present disclosure, determining the rendering strategy for the entire scene to be rendered based on the number of the triangular faces of each object may achieve the purpose of flexibly determining the rendering strategy for the scene to be rendered.

Optionally, the parameter information comprises the number of the triangular faces of each object. The above step 202 may be specifically implemented through the following steps 202f to 202g.

Step 202f: a target number range which includes the number of the triangular faces of the first object is determined, based on the number of the triangular faces of each object.

Step 202g: it is determined that a rendering strategy corresponding to the target number range is used for the first object when rendering the scene to be rendered. Wherein the first object is any of each object.

Wherein the target number range may be determined according to actual usage requirements, the rendering strategy corresponding to the target number range may be determined according to actual circumstances, and the embodiments of the present disclosure do not limit this.

It can be understood that multiple number ranges may be set (where the target number range is any of the multiple number ranges), different number ranges correspond to different rendering strategies, and different rendering strategies correspond to different N×M.

It can be understood that the number range which includes the number of the triangular faces of each object is determined based on the number of the triangular faces of each object, and then the rendering strategy corresponding to the number range which includes the number of the triangular faces of each object is determined for each object when rendering the scene to be rendered.

Exemplarily, if the multiple number ranges comprise a first number range, a second number range, a third number range, a fourth number range, and a fifth number range, any of the values in the first number range is less than any of the values in the second number range (where the smaller the value in the number range, the less of interest the objects with the number of the triangular faces falling in that number range are, and a strategy of rendering more pixel points at a time can be used for rendering), any of the values in the second number range is less than any of the values in the third number range, any of the values in the third number range is less than any of the values in the fourth number range, and any of the values in the fourth number range is less than any of the values in the fifth number range; the N×M of the rendering strategy corresponding to the first number range is 4×4, the N×M of the rendering strategy corresponding to the second number range is 4×2, the N×M of the rendering strategy corresponding to the third number range is 2×2, the N×M of the rendering strategy corresponding to the fourth number range is 1×2, and the N×M of the rendering strategy corresponding to the fifth number range is 1×1. Assuming that the scene to be rendered includes a total of three objects, namely, object 1, object 2 and object 3, where the number of the triangular faces of object 1 is in the first number range, the number of the triangular faces of object 2 is in the fifth number range, and the number of the triangular faces of object 3 is in the fourth number range, it can be determined that, when rendering the scene to be rendered, a strategy of rendering 4×4 pixel points at a time is used for object 1, a strategy of rendering 1×1 pixel point at a time is used for object 2, and a strategy of rendering 1×2 pixel points at a time is used for object 3.

In the embodiments of the present disclosure, the rendering strategy of each object is determined based on the number of the triangular faces of each object, so that the scene to be rendered may be optimized for rendering in a finer way, and the rendering speed may be better improved.

Optionally, the parameter information comprises the depth information of each object after rendering. The above step 202 may be specifically implemented through the following steps 202h to 202i.

Step 202h: a target depth range to which the depth information of the second object after rendering belongs is determined, based on the depth information of each object after rendering.

Step 202i: it is determined that a rendering strategy corresponding to the target depth range is used for the second object when rendering the scene to be rendered.

Wherein the second object is any of each object.

Wherein the target depth range may be determined according to the actual usage requirements, the rendering strategy corresponding to the target depth range may be determined according to the actual situation, and the embodiments of the present disclosure do not limit this.

It can be understood that the larger the depth information of the object after being rendered, the further away the object is from the camera, less important the object is, the smaller it will be on the screen, and the less likely it is to be an object of interest. Conversely, the smaller the depth information of the object after being rendered, the closer the object is to the camera, more important the object is, the larger it will be on the screen, and the more likely it is to be an object of interest.

It can be understood that multiple depth ranges may be set (where the target depth range is any of the multiple depth ranges), different depth ranges correspond to different rendering strategies, and different rendering strategies correspond to different N×M.

It can be understood that the depth range which includes the depth information of each object after rendering is determined based on the depth information of each object after rendering, and then the rendering strategy corresponding to the depth range which includes the depth information of each object after rendering is determined to be used for each object when rendering the scene to be rendered.

Exemplarily, if the multiple depth ranges comprise a first depth range, a second depth range, a third depth range, and a fourth depth range, any of the values in the first depth range is greater than any of the values in the second depth range (where if the value in the depth range is larger, it means that the object with the depth information after rendering being in the depth range is less of interest, and a strategy of rendering more pixels at a time can be used for rendering), any of the values in the second depth range is greater than any of the values in the third depth range, and any of the values in the third depth range is greater than any of the values in the fourth depth range; the N×M of the rendering strategy corresponding to the first depth range is 4×4, the N×M of the rendering strategy corresponding to the second depth range is 4×2, the N×M of the rendering strategy corresponding to the third depth range is 2×2, and the N×M of the rendering strategy corresponding to the fourth depth range is 1×1. Assuming that the scene to be rendered includes a total of four objects, namely, object 4, object 5, object 6, and object 7, where the depth information after rendering of object 4 is in the first depth range, the depth information after rendering of object 5 is in the third depth range, the depth information after rendering of object 6 is in the fourth depth range, and the depth information after rendering of object 7 is in the third depth range, it can be determined that, when rendering the scene to be rendered, a strategy of rendering 4×4 pixel points at a time is used for object 4, a strategy of rendering 2×2 pixel points at a time is used for object 5, a strategy of rendering 1×1 pixel point at a time is used for object 6, and a strategy of rendering 2×2 pixel points at a time is used for object 7.

In the embodiments of the present disclosure, the rendering strategy of each object is determined based on the depth information of each object after rendering, so that the scene to be rendered can be optimized for rendering in a finer way, and the rendering speed may be better improved.

Optionally, the relevant information comprises the gradient information of the mapping of the scene to be rendered and the parameter information of each object in the scene to be rendered.

Exemplarily, the relevant information comprises the gradient information of the mapping and the number of the triangular faces of each object, and the above step 202d may be specifically implemented through the following step 202d1.

Step 202d1: in a case that the gradient information of the mapping is within a target preset gradient range, the proportion of objects that satisfy the predetermined condition in the scene to be rendered is determined, based on the number of the triangular faces of each object.

It can be understood that, in the embodiments of the present disclosure, it may first be determined whether the gradient information of the mapping is in the target preset gradient range. If it is within the target preset gradient range, the proportion of objects in the scene to be rendered that satisfy the predetermined condition is determined, based on the number of triangular surfaces of each object, and in a case that the proportion is within the target ratio range, a rendering strategy corresponding to the target ratio range is determined to be used when rendering the scene to be rendered.

Wherein the specific description of step 202d1 may be referred to the above description of steps 202d, 202e, and the above description of step 202b1, and will not be repeated herein.

In the embodiments of the present disclosure, in conjunction with the gradient information of the mapping and the number of the triangular faces of each object, a suitable rendering strategy may be better determined for the scene to be rendered and the rendering speed may be improved.

Exemplarily, the relevant information comprises the gradient information of the mapping and the number of the triangular faces of each object, and the above step 202f may be specifically implemented through the following step 202f1.

Step 202f1: in a case that the gradient information of the mapping is within a target preset gradient range, the target number range which includes the number of the triangular faces of the first object is determined, based on the number of the triangular faces of each object.

It can be understood that in the embodiment of the present disclosure, it may first be determined whether the gradient information of the mapping is within the target preset gradient range. If it is within the target preset gradient range, the target number range which includes the number of the triangular faces of the first object is determined, according to the number of the triangular faces of each object, and the rendering strategy corresponding to the target number range is determined to be used for the first object when rendering the scene to be rendered.

Wherein for the specific description of step 202f1, reference may be made to the above related descriptions of steps 202f, 202g as well as the above step 202b1, which will not be described again here.

In the embodiments of the present disclosure, in conjunction with the gradient information of the mapping and the number of the triangular faces of each object, a suitable rendering strategy for the scene to be rendered may be better determined and the rendering speed may be improved.

Exemplarily, the relevant information comprises the gradient information of the mapping and the depth information of each object after rendering. The above step 202h may be specifically implemented through the following step 202h1.

Step 202h1: in a case that the gradient information of the mapping is within the target preset gradient range, the target depth range to which the depth information of the second object after rendering belongs is determined, based on the depth information of each object after rendering.

It can be understood that in the embodiment of the present disclosure, it may first be determined whether the gradient information of the mapping is within the target preset gradient range, and in a case that the gradient information of the mapping is within the target preset gradient range, the target depth range to which the depth information of the second object after rendering belongs is determined, based on the depth information of each object after rendering, and a rendering strategy corresponding to the target depth range is determined to be used for the second object when rendering the scene to be rendered.

Wherein for the specific description of step 202h1, reference may be made to the above related descriptions of steps 202h, 202i and the above step 202b1, which will not be described again here.

In the embodiments of the present disclosure, in conjunction with the gradient information of the mapping and the depth information after rendering of each object, a suitable rendering strategy may be better determined for the scene to be rendered and the rendering speed may be improved.

It should be noted, any two examples in the above method embodiments of the present disclosure may be combined again to better determine the rendering strategy when rendering the scene to be rendered. The specific rendering strategy can be determined according to actual usage requirements and will not be described in detail here.

FIG. 5 is a structural diagram of an object rendering apparatus according to the embodiments of the present disclosure. As shown in FIG. 5, it comprises: an acquisition module 501 and a rendering module 502. The acquisition module 501 is configured to acquire first position information of a target object in a scene to be rendered in a screen. The rendering module 502 is configured to, in a case that the first position information acquired by the acquisition module 501 indicates that an intersection of the target object and a user gaze area satisfies a target condition, render the target object based on a first rendering strategy. Wherein the first rendering strategy is a strategy of rendering P×Q pixel points at a time, and P and Q are positive integers.

Optionally, the rendering module 502 is specifically configured to, in a case that the first position information indicates that the intersection of the target object and the user gaze area satisfies the preset condition, acquire the first position information of the target object; and in a case that the first information satisfies a target condition, render the target object based on the first rendering strategy.

Optionally, in a case that the first information comprises a first depth value of the target object after rendering, the target condition comprises that the first depth value is less than or equal to a preset depth threshold. In a case that the first information comprises a first size value of the target object, the target condition comprises that the first size value is greater than or equal to a preset size threshold. In a case that the first information comprises gradient information of a mapping region, the target condition comprises that the gradient information of the mapping region is greater than or equal to a preset gradient threshold, the mapping region is a region of the target object in a mapping corresponding to the scene to be rendered.

In a case that the information comprises a type of the target object, the target condition comprises that the type of the target object is a preset type. In a case that the first information comprises a number of triangular faces of the target object, the target condition comprises that the number of the triangular faces of the target object is greater than or equal to a preset number threshold.

Optionally, the apparatus further comprises a determination module. The determination module is configured to, prior to rendering the target object based on the first rendering strategy, determine that rendering strategies set for the target object comprises a first rendering strategy and a second rendering strategy. The second rendering strategy is a strategy of rendering S×T pixel points at a time. P×Q is less than S×T, and S and T are positive integers.

Optionally, the rendering module 502 is specifically configured to, in a case that P×Q is less than or equal to N×M, modify the rendering strategy of the target object from a third rendering strategy to the first rendering strategy, and render the target object based on the first rendering strategy. The third rendering strategy is a strategy of rendering N×M pixel points at a time, and N and M are positive integers.

Optionally, the apparatus further comprises a determination module. The acquisition module 501 is further configured to, prior to acquiring first position information of the target object in the scene to be rendered in the screen, acquire relevant information of the scene to be rendered. The determination module is configured to determine a rendering strategy to be used when rendering the scene to be rendered, based on the relevant information. Wherein the rendering strategy comprises a strategy of rendering N×M pixel points at a time for at least one object in the scene to be rendered, and the at least one object comprises the target object.

Optionally, the relevant information comprises characteristic information of the mapping of the scene to be rendered. Wherein the characteristic information comprises at least one of the following: gradient information of the mapping, or content information of the mapping.

Optionally, the characteristic information comprises gradient information of the mapping. The determination module is specifically configured to, in a case that the gradient information of the mapping is within a target gradient range, determine that a rendering strategy corresponding to the target gradient range is used when rendering the scene to be rendered.

Optionally, the characteristic information comprises content information of the mapping. The determination module is specifically configured to, in a case that the content information of the mapping indicates that the mapping is a target content, determine that a rendering strategy corresponding to the target content is used when rendering the scene to be rendered; or, in a case that the content information of the mapping indicates that the mapping comprises a preset object, determine that a rendering strategy corresponding to the preset object is used for the preset object when rendering the scene to be rendered.

Optionally, the characteristic information further comprises gradient information of the mapping. The determination module is specifically configured to, in a case that the gradient information of the mapping is within the target preset gradient range and the mapping is the target content, determine that a rendering strategy corresponding to the target content is used when rendering the scene to be rendered; or, the determination module is specifically configured to, in a case that the gradient information of the mapping is within the target preset gradient range and the mapping comprises the preset object, determine that a rendering strategy corresponding to the preset object is used for the preset object when rendering the scene to be rendered.

Optionally, the relevant information comprises parameter information of each object in the scene to be rendered. Wherein the parameter information comprises at least one of the following: a number of triangular faces of each object, or depth information of each object after rendering.

Optionally, the parameter information comprises a number of triangular faces of each object. The determination module is specifically configured to, determine proportion of objects in the scene to be rendered that satisfy a predetermined condition, based on the number of the triangular faces of each object, and in a case that the proportion is within a target ratio range, determine that the rendering strategy corresponding to the target ratio range is used when rendering the scene to be rendered. The predetermined condition includes: the number of the triangular faces of the object is less than or equal to a threshold of the number of the triangular faces. Alternatively, the determination module is specifically configured to determine a target number range which includes the number of the triangular faces of the first object, based on the number of the triangular faces of each object, and determine that a rendering strategy corresponding to the target number range is used for the first object when rendering the scene to be rendered. The first object is any of the objects.

Optionally, the relevant information further comprises characteristic information of the mapping of the scene to be rendered. The characteristic information comprises gradient information of the mapping. The determination module is specifically configured to, in a case that the gradient information of the mapping is within a target preset gradient range, determine the proportion of objects that satisfy the predetermined condition in the scene to be rendered, based on the number of the triangular faces of each object. Alternatively, the determination module is specifically configured to, in a case that the gradient information of the mapping is within a target preset gradient range, determine the target number range which includes the number of the triangular faces of the first object, based on the number of the triangular faces of each object.

Optionally, the parameter information comprises the depth information of each object after rendering. The determination module is specifically configured to determine a target depth range to which the depth information of the second object after rendering belongs. based on the depth information of each object after rendering, and determine that a rendering strategy corresponding to the target depth range is used for the second object when rendering the scene to be rendered. Wherein the second object is any of the objects.

Optionally, the relevant information further comprises the characteristic information of the mapping of the scene to be rendered. The characteristic information comprises: the gradient information of the mapping. The determination module is specifically configured to, in a case that the gradient information of the mapping is within the target preset gradient range, determine the target depth range to which the depth information of the second object after rendering belongs, based on the depth information of each object after rendering.

In the embodiments of the present disclosure, the respective modules can implement the object rendering method provided by the method embodiment above and can achieve the same technical effect. To avoid repetition, details will not be described here.

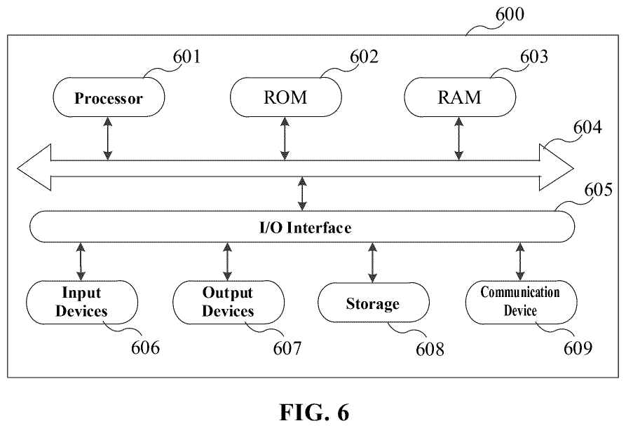

FIG. 6 is a schematic structural diagram of an electronic device provided in the embodiments of the present disclosure, and it is intended to illustrate an electronic device that implements any object rendering method according to the embodiments of the present disclosure, and should not be understood as a specific limitation on the embodiments of the present disclosure.

As shown in FIG. 6, the electronic device 600 may comprise a processor (e.g., a central processing unit, a graphics processor, etc.) 601, which may perform various appropriate actions and processes according to the program stored in the read-only memory (ROM) 602 or loaded from the storage 608 into the random access memory (RAM) 603. In the RAM 603, various programs and data required for the operation of the electronic device 600 are also stored. The processor 601, ROM 602 and RAM 603 are connected to each other through a bus 604. An input/output (I/O) interface 605 is also connected to bus 604.

Typically, the following devices may be connected to I/O interface 605; input devices 606 including, for example, a touch screen, touch pad, keyboard, mouse, camera, microphone, accelerometer, gyroscope, etc.; output devices 607 including, for example, a liquid crystal display (LCD), speakers, vibrators, etc.; storage 608 including, for example, a magnetic tape, a hard disk, etc.; and a communication device 609. The communication device 609 may allow an electronic device 600 to communicate wirelessly or wired with other devices to exchange data. Although an electronic device 600 is shown with various means, it should be understood that implementation or availability of all illustrated means is not required. More or fewer means may alternatively be implemented or provided.

Specifically, according to the embodiments of the present disclosure, the process described above with reference to the flowchart may be implemented as a computer software program. For example, the embodiments of the present disclosure include a computer program product comprising a computer program carried on a non-transitory computer-readable medium, the computer program containing program code for performing the method illustrated in the flowchart. In such embodiments, the computer program may be downloaded and installed from the network via communication device 609, or from storage 608, or from ROM 602. When the computer program is executed by the processor 601, the functions defined in any object rendering method provided by the embodiments of the present disclosure may be executed.

It should be noted that the above computer-readable medium may be a computer-readable signal medium, a computer-readable storage medium, or a combination of both. The computer-readable storage medium may be, for example, but not limited to, an electronic, magnetic, optical, electromagnetic, infrared, or semiconductive system, device or means, or any combination thereof. More specific examples of computer-readable storage media may include, but are not limited to: electrical connections having one or more wires, portable computer disks, hard disks, random access memory (RAM), read-only memory (ROM), erasable programmable read-only memory (EPROM or flash memory), optical fibers, portable compact disk read-only memory (CD-ROMs), optical storage devices, magnetic storage devices, or any suitable combination thereof. In the present disclosure, the computer-readable storage medium may be any tangible medium containing or storing programs that can be used by or in conjunction with instruction execution systems, devices, or means. Additionally, in the present disclosure, a computer-readable signal medium May include a data signal propagated in baseband or as part of a carrier wave carrying computer-readable program code therein. Such a propagated data signal may take various forms, including but not limited to electromagnetic signals, optical signals, or any suitable combination thereof. Computer-readable signal media may also include any computer-readable medium other than computer-readable storage media, which can send, propagate, or transmit programs for use by or in conjunction with instruction execution systems, devices, or means. The program code which is stored on computer-readable media may be transmitted by any suitable medium, including but not limited to wires, optical fibers. RF (radio frequency), or any suitable combination thereof.

In some embodiments, the client and server may communicate using any currently known or future developed network protocol such as HTTP (HyperText Transfer Protocol), and may be interconnected with any form or medium of digital data communication (e.g., communication networks). Examples of communication networks include local area networks (“LANs”), wide area networks (“WANs”), inter-nets (e.g., the Internet), end-to-end networks (e.g., ad hoc end-to-end networks), and any currently known or future developed network.

The above computer-readable media may be contained in the electronic devices above or may exist separately and not be assembled into the electronic devices.

The above computer-readable medium carries one or more programs, and when one or more of the programs is executed by the electronic device, the electronic device is caused to: acquire first position information of a target object in a scene to be rendered in a screen; and, in a case that the first position information indicates that an intersection of the target object and a user gaze area satisfies a preset condition, render the target object based on a first rendering strategy, wherein the first rendering strategy is a strategy of rendering P×Q pixel points at a time, and P and Q are positive integers.

In the embodiments of the present disclosure, computer program code for executing the operations disclosed herein may be written in one or more programming languages or combinations thereof. The programming languages include but are not limited to object-oriented programming languages such as Java, Smalltalk, C++, as well as conventional procedural programming languages such as “C” language or similar programming languages. The program code may be executed entirely on a computer, partially on a computer, as a standalone software package, partially on a computer and partially on a remote computer, or entirely on a remote computer or server. In cases involving remote computers, remote computers may be connected to computers via any type of network, including LANs or WANS, or connected to external computers (e.g., via the Internet using Internet service providers).

The flowcharts and block diagrams in the drawings illustrate the architecture, functionality, and operation of possible implementations of systems, methods, and computer program products in accordance with various embodiments of the present disclosure. In this regard, each block in the flowcharts or block diagrams may represent a module, a program segment, or a portion of code that contains one or more executable instructions for implementing the specified logical function. It should also be noted that in some alternative implementations, the functions labeled in the blocks may occur in a different order than labeled in the drawings. For example, two sequentially labeled blocks may actually be executed substantially concurrently, and sometimes they may also be executed in reverse order, depending on the functions involved. It should also be noted that each block in the block diagrams and/or flowcharts, as well as combinations of the blocks in the block diagrams and/or flowcharts, may be implemented using dedicated hardware-based systems that perform specified functions or operations, or may be implemented using a combination of dedicated hardware and computer instructions.

The units involved in the embodiments described in the present disclosure may be implemented in software or hardware. Wherein the name of a unit does not constitute a limitation on the unit itself under certain circumstances.

The functions described above herein may be performed, at least in part, by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logic device (CPLD), etc.

In the context of the present disclosure, the computer-readable medium may be a tangible medium that may contain or store a program for use by or in connection with an instruction execution system, device, or means. The computer-readable medium may be a computer-readable signal medium or r a computer-readable storage medium. Computer-readable media may include, but are not limited to, electronic, magnetic, optical, electromagnetic, infrared, or semiconductive systems, devices or means, or any suitable combination thereof. More specific examples of computer-readable storage media include electrical connections based on one or more wires, portable computer disks, hard disks, random access memory (RAM), read-only memory (ROM), erasable programmable read-only memory (EPROM or flash memory), optical fibers, portable compact disk read-only memory (CD-ROMs), optical storage devices, magnetic storage devices, or any suitable combination thereof.

The above description is only a description of the preferred embodiments of the present disclosure and the technical principles applied. Those skilled in the art should understand that the disclosure scope involved in the present disclosure is not limited to technical solutions formed by specific combinations of the above technical features, but should also cover other technical solutions formed by any combination of the above technical features or their equivalent features without departing from the above disclosed concept. For example, technical solutions formed by replacing the above features with technical features disclosed in the present disclosure (but not limited to) with similar functions are also included.

In addition, although specific sequences have been described for the various operations. this should not be interpreted as requiring the operations to be performed in the specific sequence or in the order shown. In certain environments, multitasking and parallel processing may be advantageous. Similarly, although various specific implementation details have been included in the above description, these should not be interpreted as limiting the scope of the present disclosure. Certain features described in the context of separate embodiments may also be implemented in combination in a single embodiment. Conversely, various features described in the context of a single embodiment may also be implemented separately or in any appropriate sub-combination in multiple embodiments.

Although the subject matter has been described with reference to specific structural features and/or method logical actions, it should be understood that the subject matter defined in the appended claims is not necessarily limited to the specific features or actions described above. Instead, the specific features and actions described above are merely exemplary forms of implementing the claims.

1. An object rendering method, comprising:
acquiring first position information of a target object in a scene to be rendered in a screen; and
rendering, in a case that the first position information indicates that an intersection of the target object and a user gaze area satisfies a preset condition, the target object based on a first rendering strategy,
wherein the first rendering strategy is a strategy of rendering P×Q pixel points at a time, and P and Q are positive integers.

2. The method according to claim 1, wherein the rendering, in the case that the first position information indicates that the intersection of the target object and the user gaze area satisfies the preset condition, the target object based on the first rendering strategy comprises:
acquiring, in the case that the first position information indicates that the intersection of the target object and the user gaze area satisfies the preset condition, first information of the target object; and
rendering, in a case that the first information satisfies a target condition, the target object based on the first rendering strategy.

3. The method according to claim 2, wherein in a case that the first information comprises a first depth value of the target object after rendering, the target condition comprises that the first depth value is less than or equal to a preset depth threshold;
wherein in a case that the first information comprises a first size value of the target object, the target condition comprises that the first size value is greater than or equal to a preset size threshold;
wherein in a case that the first information comprises gradient information of a mapping region, the target condition comprises that the gradient information of the mapping region is greater than or equal to a preset gradient threshold, the mapping region is a region of the target object in a mapping corresponding to the scene to be rendered;
wherein in a case that the first information comprises a type of the target object, the target condition comprises that the type of the target object is a preset type; and
wherein in a case that the first information comprises a number of triangular faces of the target object, the target condition comprises that the number of the triangular faces of the target object is greater than or equal to a preset number threshold.

4. The method according to claim 1, wherein the method further comprises prior to rendering the target object based on the first rendering strategy;
determining that rendering strategies set for the target object comprises a first rendering strategy and a second rendering strategy;
wherein the second rendering strategy is a strategy of rendering S×T pixel points at a time, P×Q is less than S×T, and S and T are positive integers.

5. The method according to claim 1, wherein the rendering the target object based on a first rendering strategy comprises:
modifying, in a case that P×Q is less than or equal to N×M, the rendering strategy of the target object from a third rendering strategy to the first rendering strategy, and rendering the target object based on the first rendering strategy;
wherein the third rendering strategy is a strategy of rendering N×M pixel points at a time, and N and M are positive integers.

6. The method according to claim 5, wherein the method further comprises prior to acquiring the first position information of the target object in the scene to be rendered in the screen:
acquiring relevant information of the scene to be rendered; and
determining, based on the relevant information, a rendering strategy to be used when rendering the scene to be rendered,
wherein the rendering strategy comprises a strategy of rendering N×M pixel points at a time for at least one object in the scene to be rendered, and the at least one object comprises the target object.

7. The method according to claim 6, wherein the relevant information comprises characteristic information of a mapping of the scene to be rendered; and
wherein the characteristic information comprises at least one of the following: gradient information of the mapping, or content information of the mapping.

8. The method according to claim 7, wherein the characteristic information comprises the gradient information of the mapping; and
wherein the determining, based on the relevant information, the rendering strategy to be used when rendering the scene to be rendered comprises:
determining, in a case that the gradient information of the mapping is within a target gradient range, that a rendering strategy corresponding to the target gradient range is used when rendering the scene to be rendered.

9. The method according to claim 7, wherein the characteristic information comprises the content information of the mapping; and
wherein the determining, based on the relevant information, the rendering strategy to be used when rendering the scene to be rendered comprises:
determining, in a case that the content information of the mapping indicates that the mapping is a target content, that a rendering strategy corresponding to the target content is used when rendering the scene to be rendered; or
determining, in a case that the content information of the mapping indicates that the mapping comprises a preset object, that a rendering strategy corresponding to the preset object is used for the preset object when rendering the scene to be rendered.

10. The method according to claim 9, wherein the characteristic information further comprises the gradient information of the mapping; and
wherein the determining, in the case that the content information of the mapping indicates that the mapping is the target content, that the rendering strategy corresponding to the target content is used when rendering the scene to be rendered comprises: determining, in a case that the gradient information of the mapping is within a target preset gradient range and the mapping is the target content, that the rendering strategy corresponding to the target content is used when rendering the scene to be rendered; or
wherein the determining, in the case that the content information of the mapping indicates that the mapping comprises the preset object, that the rendering strategy corresponding to the preset object is used for the preset object when rendering the scene to be rendered comprises:
determining, in a case that the gradient information of the mapping is within the target preset gradient range and the mapping comprises the preset object, that the rendering strategy corresponding to the preset object is used for the preset object when rendering the scene to be rendered.

11. The method according to claim 6, wherein the relevant information comprises parameter information of each object in the scene to be rendered; and
wherein the parameter information comprises at least one of the following: a number of triangular faces of each object, or depth information of each object after rendering.

12. The method according to claim 11, wherein the parameter information comprises the number of the triangular faces of each object; and
wherein the determining, based on the relevant information, the rendering strategy to be used when rendering the scene to be rendered comprises:
determining, based on the number of the triangular faces of each object, a proportion of objects in the scene to be rendered that satisfy a predetermined condition, wherein the predetermined condition comprises that the number of the triangular faces of the object is less than or equal to a number threshold of the triangular faces; and
determining, in a case that the proportion is within a target ratio range, that a rendering strategy corresponding to the target ratio range is used when rendering the scene to be rendered; or
wherein the determining, based on the relevant information, the rendering strategy to be used when rendering the scene to be rendered comprises:
determining, based on the number of the triangular faces of each object, a target number range which comprises the number of the triangular faces of a first object; and
determining that a rendering strategy corresponding to the target number range is used for the first object when rendering the scene to be rendered, the first object being any of each object.

13. The method according to claim 12, wherein the relevant information further comprises characteristic information of a mapping of the scene to be rendered, the characteristic information comprises gradient information of the mapping; and
wherein the determining, based on the number of the triangular faces of each object, the proportion of objects in the scene to be rendered that satisfy the predetermined condition comprises: determining, in a case that the gradient information of the mapping is within a target preset gradient range, the proportion of objects that satisfy the predetermined condition in the scene to be rendered, based on the number of the triangular faces of each object; or
wherein the determining, based on the number of the triangular faces of each object, the target number range which comprises the number of the triangular faces of the first object comprises: determining, in a case that the gradient information of the mapping is within the target preset gradient range, the target number range which comprises the number of the triangular faces of the first object, based on the number of the triangular faces of each object.

14. The method according to claim 11, wherein the parameter information comprises the depth information of each object after rendering;
wherein the determining, based on the relevant information, the rendering strategy to be used when rendering the scene to be rendered comprises:
determining, based on the depth information of each object after rendering, a target depth range to which the depth information of the second object after rendering belongs; and
determining that a rendering strategy corresponding to the target depth range is used for the second object when rendering the scene to be rendered;
wherein the second object is any of each object.

15. The method according to claim 14, wherein the relevant information further comprises characteristic information of a mapping of the scene to be rendered, the characteristic information comprises gradient information of the mapping; and
wherein the determining, based on the depth information of each object after rendering, the target depth range to which the depth information of the second object after rendering belongs comprises:
determining, in a case that the gradient information of the mapping is within a target preset gradient range, the target depth range to which the depth information of the second object after rendering belongs, based on the depth information of each object after rendering.

16. (canceled)

17. An electronic device, comprising a memory and a processor, wherein the memory is configured to store a computer program, and the processor is configured to, when invoking the computer program:
acquire first position information of a target object in a scene to be rendered in a screen; and
render, in a case that the first position information indicates that an intersection of the target object and a user gaze area satisfies a preset condition, the target object based on a first rendering strategy,
wherein the first rendering strategy is a strategy of rendering P×Q pixel points at a time, and P and Q are positive integers.

18. A non-transitory computer-readable storage medium, having a computer program stored thereon, wherein the computer program, when executed by a processor, is cause to:
acquire first position information of a target object in a scene to be rendered in a screen; and
render, in a case that the first position information indicates that an intersection of the target object and a user gaze area satisfies a preset condition, the target object based on a first rendering strategy,
wherein the first rendering strategy is a strategy of rendering P×Q pixel points at a time, and P and Q are positive integers.

19. (canceled).

20. The electronic device according to claim 17, wherein the computer program causing the processor to render, in the case that the first position information indicates that the intersection of the target object and the user gaze area satisfies the preset condition, the target object based on the first rendering strategy further causes the processor to:
acquire, in the case that the first position information indicates that the intersection of the target object and the user gaze area satisfies the preset condition, first information of the target object; and
render, in a case that the first information satisfies a target condition, the target object based on the first rendering strategy.

21. The electronic device according to claim 20, wherein in a case that the first information comprises a first depth value of the target object after rendering, the target condition comprises that the first depth value is less than or equal to a preset depth threshold;
wherein in a case that the first information comprises a first size value of the target object, the target condition comprises that the first size value is greater than or equal to a preset size threshold;
wherein in a case that the first information comprises gradient information of a mapping region, the target condition comprises that the gradient information of the mapping region is greater than or equal to a preset gradient threshold, the mapping region is a region of the target object in a mapping corresponding to the scene to be rendered;
wherein in a case that the first information comprises a type of the target object, the target condition comprises that the type of the target object is a preset type; and
wherein in a case that the first information comprises a number of triangular faces of the target object, the target condition comprises that the number of the triangular faces of the target object is greater than or equal to a preset number threshold.

22. The electronic device according to claim 17, wherein when invoking the computer program, the processor is further configured to, prior to rendering the target object based on the first rendering strategy:
determine that rendering strategies set for the target object comprises a first rendering strategy and a second rendering strategy;
wherein the second rendering strategy is a strategy of rendering S×T pixel points at a time, P×Q is less than S×T, and S and T are positive integers.
